(19) United States
(12) Patent Application Publication
(10) Pub. No.: US 2009/0044708 A1
(43) Pub. Date: Feb. 19, 2009

(54) Device for cutting fruit and vegetables, in particular onions

(76) Inventors: Cedomir Repac, Brechen (DE); Branko Culig, Metlika (SI)

Correspondence Address: Charles P. Boukus, Jr., Suite 202, 2001 Jefferson Davis Highway, Arlington, VA, 22202, US

(21) Appl. No.: 12/285,655

(22) Filed: Oct. 10, 2008

Related U.S. Application Data
(63) Continuation of application No. 11/320,631, filed on Dec. 30, 2005, now Pat. No. 7,444,909.
Application No. 11/320,631 is a division of application No. 10/893,883, filed on Jul. 20, 2004, now abandoned.

(30) Foreign Application Priority Data
Feb. 18, 2004 (DE) 20 2004 002 477.2

(51) Int. Cl. A47J 43/04; B26D 1/03

(52) U.S. Cl. 99/537; 83/856

(57) ABSTRACT

The invention relates to a device for cutting fruit and vegetables, in particular onions, having a cutter member (3) that has a plurality of blades (2) and having a counterpart element (4) against which the cutter member (3) is pressed for cutting the material to be cut, wherein the counterpart element (4) has a punch (5) which presses the material to be cut through the cutter member (3), or the blades (2) thereof. For receiving the cut material, a container (6) is releasably disposed on the cutter member (3), on its side remote from the counterpart element (4), in the region of the blades (2). The container (6) is mounted upside down on the cutter member (3) to allow a user to operate the device with two hands by pressing with one hand on a free end of the cutter member (3) and by pressing with the other hand on the bottom of the container (6) to pivot the cutter member (3) downward.

### CROSS-REFERENCE TO RELATED APPLICATIONS

This application is a continuation of U.S. patent application Ser. No. 11/320,631 filed Dec. 30, 2005 which is a division of U.S. patent application Ser. No. 10/893,883 filed Jul. 20, 2004.

### FIELD OF THE INVENTION

The invention relates to a device for cutting fruit and vegetables, in particular onions, having a cutter member that has a plurality of blades and having a counterpart element against which the cutter member is pressed for cutting the material to be cut, wherein the counterpart element has a punch which presses the material to be cut through the cutter member, or the blades thereof.

### BACKGROUND OF THE INVENTION

An onion chopper of this kind is known for instance from International Patent Disclosure WO 02064331A1, with a boardlike cutter element and a counterpart element, likewise embodied on the order of a board, that receives the onion to be cut. For cutting an onion, the cutter element is pivoted upward from the counterpart element that rests on an underlying support, and the onion to be cut is placed on a punch located on the counterpart element. After that, the cutter element is pivoted back onto the counterpart element, exerting a pressure, until the blades plunge into corresponding indentations on the punch. In the process, the onion is cut apart by the cutting grid of the cutter element and by means of the punch is pressed all the way through the cutting grid. Once the cutter element rests on the counterpart element, the material that has been cut is located on the top side of the cutter element and can be removed from the cutter element, for instance with the aid of a knife.

A disadvantage of this device is that pieces of the cut onion can drop unintentionally from the top side of the cutter element, for instance onto the floor. This often occurs when onions are being cut, since because of their oval shape the onion tends to fall apart after being cut.

A further disadvantage in this device is that the essential oils of the onion can develop freely after the cutting, causing the well-known irritation to the eyes of the user. It is also necessary to remove the cut onion from the top side of the cutter element when further onions are to be cut.

Furthermore, cleaning the punch proves difficult, since the essential oils of the onion can collect in the indentations in the punch, and the counterpart element can be cleaned only together with the punch.

### SUMMARY OF THE INVENTION

It is therefore the object of the invention to further develop a device for cutting fruit and vegetables, in particular onions, having the characteristics recited at the outset, in such a way that while overcoming these disadvantages, handling of the device is improved substantially.

This object is attained by a device having the characteristics recited at the outset, in which for receiving the cut material, a container is releasably disposed on the cutter member, on its side remote from the counterpart element, in the region of the blades.

By means of the invention, it is attained that the cut onions, for instance, after being cut are received in the container and are secured against falling out. Also, the essential oils of a cut onion, for instance, cannot develop their eye-irritating effect, since they are essentially locked away from the environment by the container. Moreover, the container according to the invention offers the advantage that a plurality of kinds of material to be cut can be cut in succession, without requiring that the already-cut material be removed from the device and placed in a separate container. Once the desired quantity of vegetables, onions and the like has been cut, the device of the invention is simply turned over, so that the receiving container is now underneath the cutter element. The container is then released from the device, whereupon the cut material is held in the container and can be kept ready for further processing. In order here as well to suppress the irritating effect of the essential oils of a cut onion, a separate cap for closing the container once it has been released from the device may be provided. The cut material can then be stored in the container in airtight fashion until it is further processed.

In a first advantageous embodiment of the invention, the container is retained releasably on the cutter element by means of a bayonet mount. Alternatively, however, it is possible to use a screw closure or a detent connection. All these means assure fast, simple release of the container from the cutter element and its fastening to it.

To enable monitoring the fill level inside the container, in an embodiment of the invention the container comprises transparent material.

In a further concept of the invention, the punch is releasably held on the counterpart element, so that after use the punch can be released from the counterpart element and subjected separately to intensive cleaning. This is especially applicable whenever the cut material releases eye-irritating essential oils that can stick to the punch.

In this respect as well, for simple, fast release of the punch from the counterpart element and securing it to the counterpart element, it is provided that the punch is releasably disposed on the counterpart element by means of a bayonet mount. Screw closures but in particular detent connections are preferably employed.

To prevent the punch, in the cutting of the material to be cut and in particular when detent connections are used between the punch and the material, from being released unintentionally from the counterpart element by the pressure exerted on the material to be cut, the punch can be disposed in captive fashion on the counterpart element by means of fastening elements.

It has proved advantageous that the fastening elements have at least one clamping means that can be secured to the counterpart element and the punch by means of screws or similar fastening means.

In another especially advantageous embodiment of the invention, the blades form a cutting grid. As a result, the material to be cut is cut into small block-shaped pieces, which in the case of onions, for instance, because of their shell-like structure, fall apart into more or less small pieces or cubes of onion. In this respect only one cutting operation is required to obtain cut material that is cut as small as possible. In that case, the punch on the counterpart element should have a likewise gridlike structure of its indentations that the cutting grid engages.

In a further advantageous embodiment of the invention, the cutter element and the counterpart element are supported pivotably on one another. Since the cutter element acts as a lever, the expenditure of force in cutting is reduced considerably.

To assure simple, thorough cleaning of the individual parts of the device of the invention, it is provided that the cutter element and the counterpart element are likewise releasably joined together.

In still a further concept of the invention, both the counterpart element and the cutter element are embodied in boardlike fashion, which simplifies handling of the device substantially.

It is furthermore provided that blades are retained in a frame disposed releasably on the cutter element. As a result, the blades can easily be released from the cutter element and subject to thorough cleaning. The blades can also be replaced easily, if they should have become dull after long use.

Further characteristics, advantages, embodiments and possible applications of the present invention will become apparent from the ensuing description of one exemplary embodiment in conjunction with the drawings. All the characteristics described and/or shown in the drawing are the subject of the present invention on their own or in arbitrary appropriate combination, including independently of how they are summarized in the claims or the claims dependencies.

### BRIEF DESCRIPTION OF THE DRAWINGS

Shown are:

FIG. 1, one possible embodiment of a device according to the invention with a cutter element and counterpart element pivotable counter to one another;

FIG. 2, the device of FIG. 1, with the cutter element resting on the counterpart element;

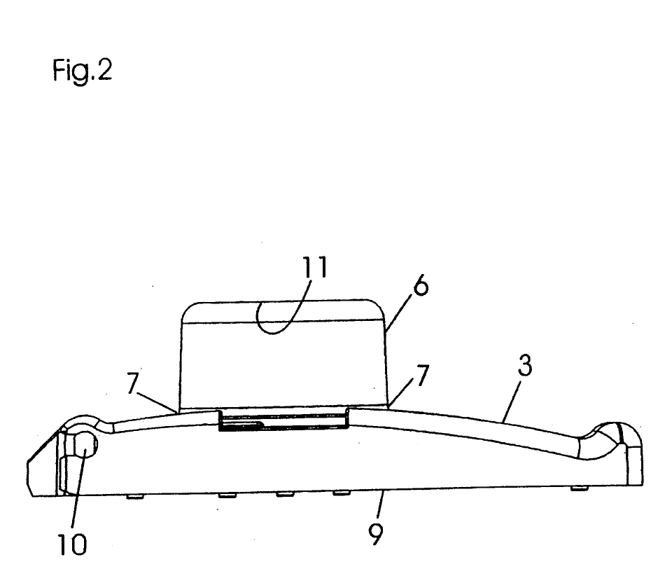

FIG. 3, the device of FIGS. 1 and 2, after the material to be cut has been cut and before the container that receives the cut vegetables or onions is released;

FIG. 4, an exploded view in perspective of the device of FIGS. 1-3, with a releasable punch;

FIG. 5, an exploded view in perspective of the device of FIGS. 1-3, with a cutting grid retained in a releasable frame;

FIG. 6, an exploded view in perspective of the device, with additional fastening elements for the punch; and

FIG. 7, a plan view on the underside of the counterpart element of the device, with a punch disposed in captive fashion with fastening elements, in accordance with FIG. 6.

### DETAILED DESCRIPTION OF PREFERRED EMBODIMENT

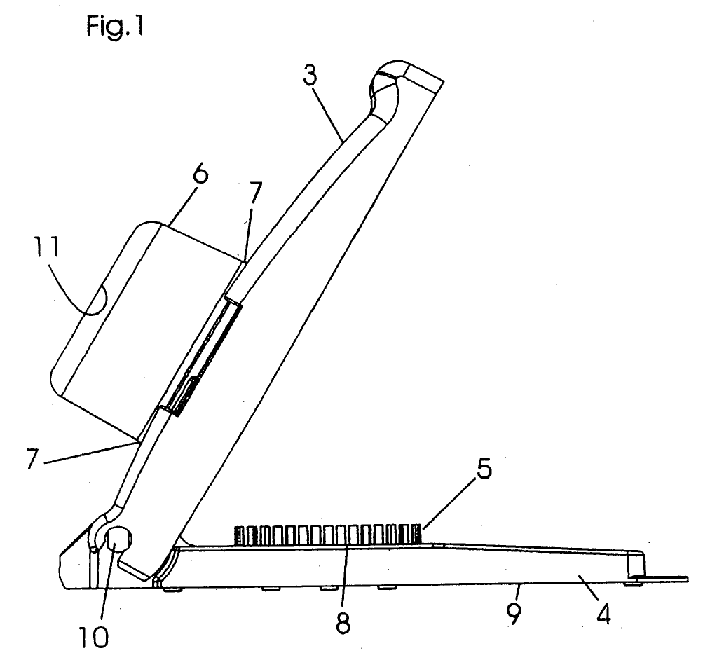

The device shown in the drawings substantially comprises a cutter element 3 and a counterpart element 4, as the drawings show. As FIG. 1 shows, in the embodiment selected here, the cutter element 3 and the counterpart element 4 are supported pivotably counter to one another via a pivot connection 10.

A plurality of blades 2 combined into a grid are integrated into the cutter element 3.

On the side of the cutter element 3 remote from the counterpart element 4, in the region of the cutting grid, a container 6 is retained releasably by means of a bayonet mount 7.

The counterpart element 4 has a base 9, for placing the device on a work surface (not shown). The base 9 is disposed on the side of the counterpart element 4 remote from the cutter element 3. On the side of the counterpart element 4 toward the cutter element 3, there is a punch 5, on which the onion or similar material to be cut is placed.

The punch 5 has indentations 8, which correspond with the blades 2 of the cutter element 3 and into which the blades 2 dip when the cutter element 3 is resting on the counterpart element 4. To press the onion all the way through the blades 2, the indentations 8 are embodied as deeper than the height of the blades 2.

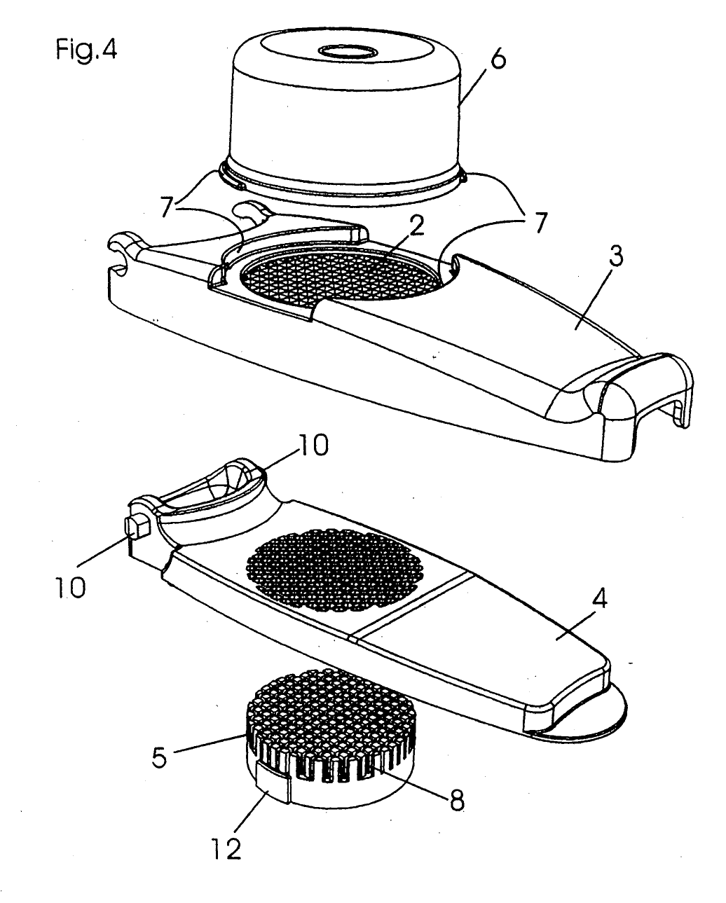

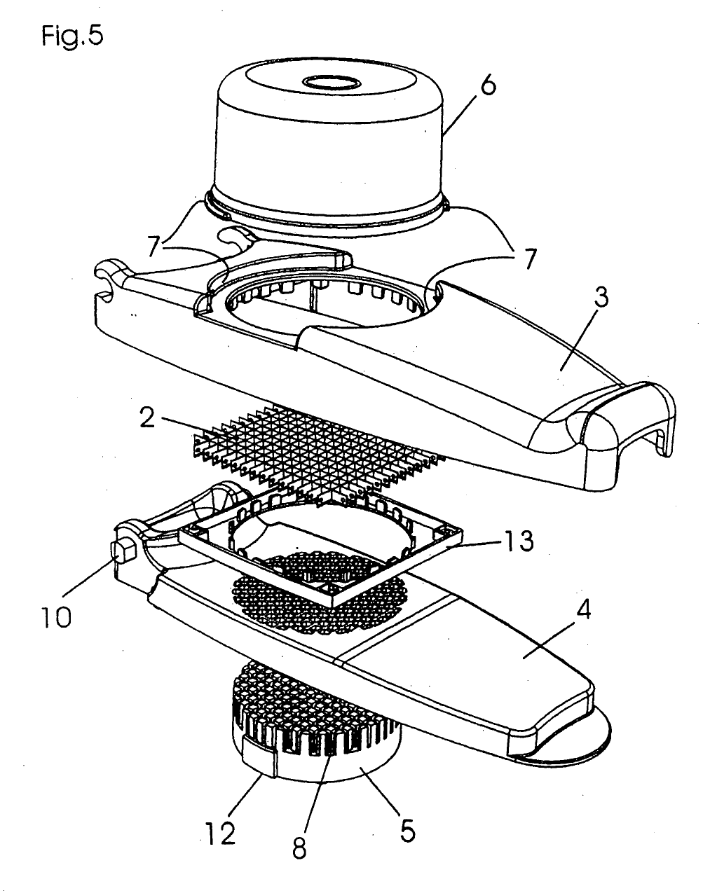

As can be seen particularly in FIGS. 4 and 5, the punch 5 is releasably retained on the counterpart element 4 by means of a detent connection 12.

The blades 2 in FIG. 5 are likewise retained in a frame 13, which in turn is disposed releasably on the cutter element 3.

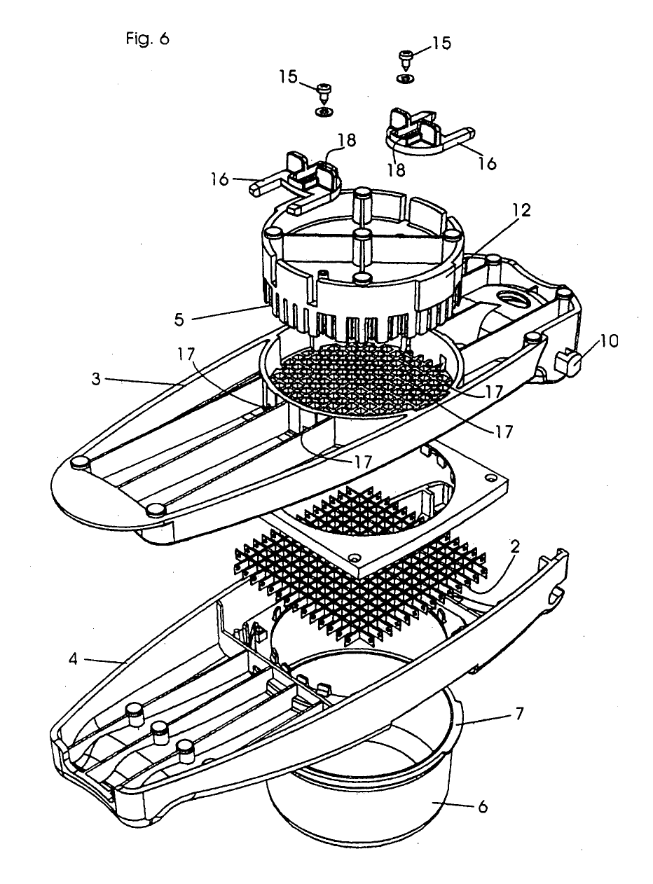

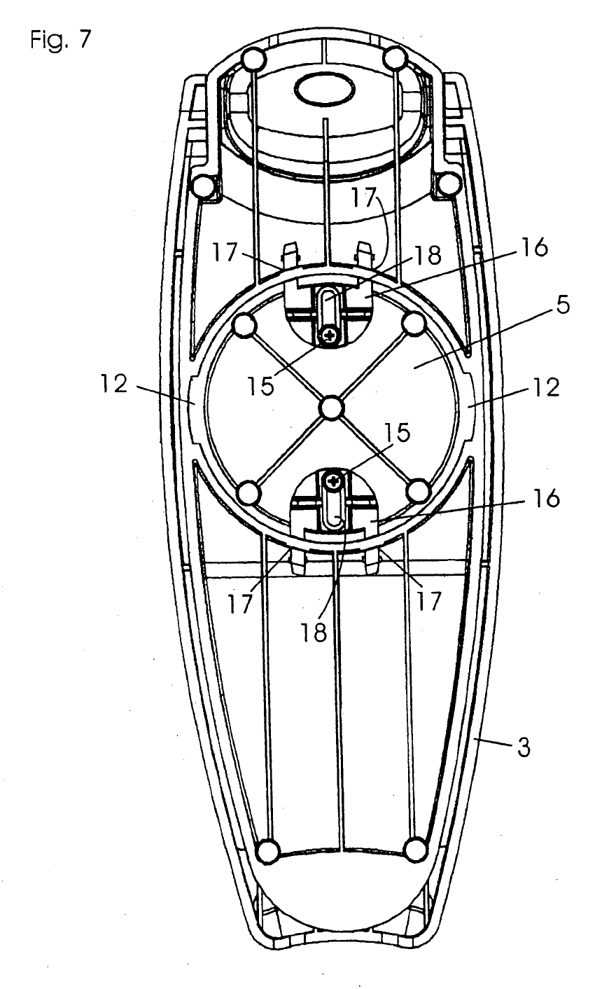

In the exemplary embodiment of FIGS. 6 and 7, the punch 5 is disposed in captive fashion on the counterpart element 4 by means of fastening elements. The fastening elements are formed by clamping means 16, which are retained on the punch 5 by means of screws 15. For that purpose, each clamping means 16 has one oblong slot 18 for the screw 15, as a result of which the clamping means 16 are held displaceably on the underside of the punch 5. The clamping means 16 can be displaced longitudinally of the oblong slot 18, so that the clamping means 16 extend in part through openings 17 inside the counterpart element 4. If in cutting of the material to be cut, a high pressure is exerted on the punch 5, then the fastening elements in the form of the clamping means 16 with screws 15 retain the punch 5 in captive fashion on the counterpart element 4.

Before the cutting operation, the counterpart element 3 is pivoted upward relative to the counterpart element 4, and the material to be cut is placed on the punch 5. In this position, the container 6 is located on the top side of the cutter element 3. The cutter element 3 is now pressed downward onto the counterpart element 4, whereupon the blades 2 cut the material to be cut into pieces of rectangular cross section. Once the cutter element 3 is resting on the counterpart element 4, the material being cut has been pressed by the punch 5 all the way into the container 6, through the blades 2 in the cutting grid.

The blades 2 of the cutting grid are arranged such that in the event that the cutter element 3 is pivoted again for cutting further onions, the cut material is prevented from falling out of the container 6 through the cutting grid. The quantity of cut material can be checked, because of the transparent container 6.

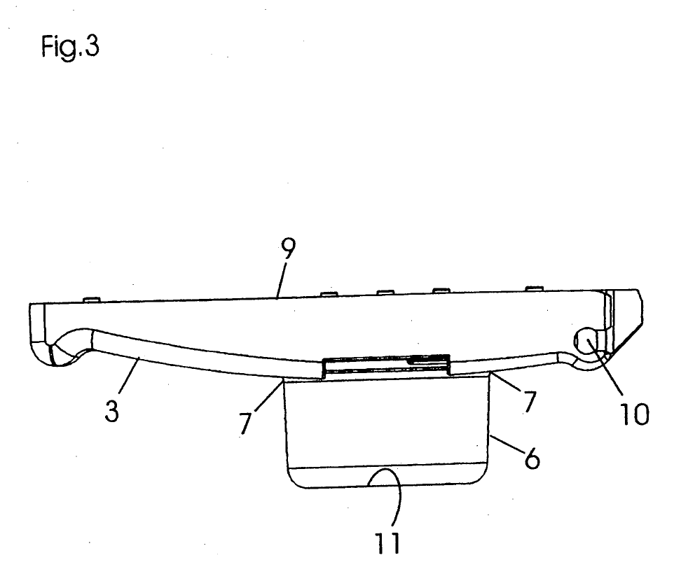

As soon as there is a desired quantity of cut material in the container 6, the device is turned over into the position shown in FIG. 3, in which the cut material is located on the bottom 11 of the container 6. The container 6 can now be released from the cutter element 3, and if the cut vegetables are not processed immediately, the container can optionally be closed with a cap.

For cleaning the device, its individual parts, such as the cutter element 3, counterpart element 4, punch 5, container 6, blades 2, and frame 13, can be separated from one another.

### LIST OF REFERENCE NUMERALS

2 Blades
3 Cutter element
4 Counterpart element
5 Punch
6 Container
7 Bayonet mount
8 Indentations
9 Base
10 Pivot connection
11 Bottom
12 Detent connection
13 Frame
15 Screws
16 Clamping means
17 Opening
18 Oblong slot

1. A device for cutting fruits and vegetables, comprising:
a cutter member (3) including a plurality of blades (2),
a counterpart element (4) against which the cutter member (3) is pressed for cutting the material to be cut, wherein the counterpart element (4) has a punch (5) which presses the material to be cut through the blades (2) of the cutter member (3),
said cutter member (3) and said counterpart element (4) comprising boardlike members which are pivotally connected at one end thereof,
said counterpart element (4) having a base (9) which rests on a work surface during the cutting action of the device,
said cutter member (3) and said counterpart element (4) being supported for pivotal movement relative to one another to allow the blades to pivot downward against the punch (5) to cut a fruit or vegetable placed on the punch (5),
a container (6) mounted upside down on the top of the cutter member (3) remote from the counterpart element (4) for receiving the cut material pressed by the punch (5) through the blades (2) of the cutter member (3) with the container (6) upside down and for collecting the cut material when the device is turned over to orient the container (6) upright,
said container (6) having an open top mounted adjacent to the blades of the cutter member (3) and a closed bottom (11) projecting upward from the cutter member (3) during the cutting action of the device,
means for releasably fastening the top of the container (6) to the top of the cutter member (3) whereby the container (6) can be attached to and separated from the cutter member (3) by a user, and wherein
said closed bottom of the container is exposed to allow a user to operate the device with two hands by pressing with one hand on a free end of the cutter member and by pressing with the other hand on the bottom of the container to pivot the cutter member downward.

2. The device of claim 1, wherein the container (6) is mounted at an intermediate position along the cutter member (3) between the pivotally connected end and the free end of the cutter member (3).

3. The device of claim 2, wherein the container (6) is mounted at a position surrounding the blades to allow the user to exert a force on the cutter member (3) in the area of the blades by pressing on the container.

4. The device of claim 3, wherein the bottom of the container (6) has a rounded peripheral edge to be comfortably gripped by the user during the operation of the device.

5. The device of claim 3, wherein the top of the cutter member (3) has a recessed area formed therein adjacent to the blades for receiving the top of the container (6).

6. The device of claim 5, wherein the blades are located in an opening formed in the top of the cutter member (3) within the recessed area of the cutter member (3).

7. The device of claim 6, wherein the cutter member (3) includes a ledge extending around the opening in the recessed area for engaging the top of the container (6) when the container (6) is placed into the recessed area.

8. A device for cutting fruits and vegetables, comprising:
a cutter member (3) including a plurality of intersecting blades (2),
a counterpart element (4) including a punch (5) which presses the material to be cut through the intersecting blades (2) of the cutter member (3) when the cutter member (3) and the counterpart element (4) are pressed together,
said cutter member (3) and said counterpart element (4) comprising boardlike members which are pivotally connected at one end thereof,
said counterpart element (4) having a base (9) which rests on a work surface during the cutting action of the device,
said counterpart element (4) being located below and pivotally connected to the cutter member (3) to allow the blades to pivot downward against the punch (5) on the counterpart element (4) to cut a fruit or vegetable placed on the punch (5),
said punch (5) including a plurality of projections for supporting the fruit or vegetable which provide a plurality of indentations (8) corresponding with the intersecting blades (2) of the cutter element (3) for receiving the blades (2) when the cutter element (3) and the counterpart element (4) are pivoted together,
a container (6) mounted in an inverted position on the top of the cutter member (3) remote from the counterpart element (4) for receiving the cut material pressed by the punch (5) through the blades (2) of the cutter member (3) with the container (6) in the inverted position and for collecting the cut material when the device is turned over to orient the container (6) in an upright position,
said container (6) having an open top mounted adjacent to the blades of the cutter member (3) and a closed bottom (11) projecting upward from the cutter member (3) during the cutting action of the device,
one or more fasteners on the container (6) for releasably fastening the top of said container (6) to the top of the cutter member (3) whereby the container (6) can be attached to and separated from the cutter member (3) by a user, and wherein
said closed bottom of the container is exposed to allow a user to operate the device with two hands by pressing with one hand on a free end of the cutter member and by pressing with the other hand on the bottom of the container to pivot the cutter member downward.

9. The device of claim 8, wherein the container (6) is mounted at an intermediate position along the cutter member (3) between the pivotally connected end and the free end of the cutter member (3).

10. The device of claim 9, wherein the container (6) is mounted at a position surrounding the blades to allow the user to exert a force on the cutter member (3) in the area of the blades by pressing on the container.

11. The device of claim 10, wherein the bottom of the container (6) has a rounded peripheral edge to be comfortably gripped by the user during the operation of the device.

12. The device of claim 10, wherein the top of the cutter member (3) has a recessed area formed therein adjacent to the blades for receiving the top of the container (6).

13. The device of claim 12, wherein the blades are located in an opening formed in the top of the cutter member (3) within the recessed area of the cutter member (3).

14. The device of claim 13, wherein the cutter member (3) includes a ledge extending around the opening in the recessed area for engaging the top of the container (6) when the container (6) is placed into the recessed area.
